(19) United States
(12) Patent Application Publication
(10) Pub. No.: US 2008/0063592 A1
(43) Pub. Date: Mar. 13, 2008

(54) Spherical Active Carbon And Process For Producing The Same

(75) Inventors: Fumio Nakahara, Okayama (JP); Kuroo Kizaki, Okayama (JP); Akira Miyake, Osaka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KURARAY CHEMICAL CO., LTD, Bizen-shi (JP)

(21) Appl. No.: 11/597,265

(22) PCT Filed: May 16, 2005
(86) PCT No.: PCT/JP05/08886

§ 371 Date: Nov. 20, 2006

(30) Foreign Application Priority Data
May 20, 2004 (JP) 2004-149920

(51) Int. Cl. C01B 31/08

(52) U.S. Cl. 423/449.1; 264/29.6; 423/445 R

(57) ABSTRACT

An active carbon produced from an infusible carbonaceous material as a raw material, which active carbon when used for prevention of automobile fuel evaporation, etc., would not cause any trouble attributed to dust generation, exhibiting reduced pressure loss; and a process for producing the same. There is provided a spherical active carbon produced from an infusible solid carbon material as a raw material, wherein providing that x represents an average particle diameter (mm) and y an MS hardness (%), when x is in the range of 0.5 to 20, y is ≧100×(1-0.8×1.45^{(0.3-x)}). This spherical active carbon can be produced by a process comprising mixing a carbon material with a carbonizable binder; extruding the mixture into a strand form; carrying out rolling granulation so as to obtain a spherical form; rendering the same infusible under appropriate conditions corresponding to the particle size; and performing carbonization and thereafter activation under conditions appropriately restricting the contact with activation gas.

### TECHNICAL FIELD OF THE INVENTION

The present invention relates to a spherical activated carbon. More particularly, the present invention relates to a spherical activated carbon having high hardness produced from an infusible solid carbon material as a raw material.

### BACKGROUND OF THE INVENTION

An activated carbon, which has an excellent ability of adsorbing various hazardous substances and offensive odor substances, has been conventionally used as an adsorbent in a variety of fields for both household and industrial purposes. Such activated carbon is used in various forms such as powder and pellet forming materials, depending on the applications.

In recent years, since the use of the activated carbon has been increasingly expanded, the performance required for the activated carbon has become strict according to the use of the carbon. For example, an application of the activated carbon to a filter for removing automobile fuel vapor has been advanced. However, when the automobile is equipped with an activated carbon filter, strict control of dust generation prevention is required because adverse effects occur, that is, the filter is exposed to a long-term vibration to likely cause dust generation, and once dust generation occurs, fine particles are mixed into the exhaust system to cause trouble.

Furthermore, a superior low dust generation property is desirable in the same way, such as the cases where the activated carbon is used for absorbing hazardous substances in a clean room for producing drugs and the like; where the activated carbon is used for absorbing hazardous substances inside or in their vicinity of precision equipment and an electronic device which dislike dust, for example, for absorbing substances which exert an influence on a hard disk of computer and the like; or where the activated carbon is used for a constant or higher flow rate of a gas, for example, used for a pressure swing system gas separation device.

Moreover, in the applications accompanied by circulation of a gas such as the filter removing automobile fuel vapor, it is also practically important that the pressure loss is small, and high absorption ability is naturally required in all applications.

For the above-mentioned applications, there is a method of using an activated carbon in a pulverized or a pellet form. However, because of edge parts in pulverized or a pellet form, it is difficult to considerably reduce the dust generation attributed to a defect in filling into a container and a defect of the edge parts in the case where vibration is given over a long time when in use. In addition, the pressure loss tends to increase due to the irregular filling. Meanwhile, for example, if a forming material and the like in a honeycomb form is used, the problem of the dust generation is alleviated, however, the absorption ability tends to be decreased because the surface area may not be secured to the degree that the activated carbon in a pellet or a powder form is filled.

Therefore, a spherical form is desirable in order to satisfy the above-mentioned required performance. A spherical activated carbon would not cause dust generation, accompanied by fracturing when filled into a container, because of absence of edges in the form, and would not increase drift and pressure loss due to the irregular filling. Moreover, since the spherical activated carbon has an excellent flowability when it is used by fluidizing, it is easy to fill into a container having a complicated form and it is suitably used to treat a liquid by a system in which an activated carbon is fluidized.

There have been conventionally known a variety of spherical activated carbons and production methods thereof. When the spherical activated carbons are broadly classified by production methods, there are the following two methods: (1) a method in which a liquid or fused material is dispersed in a dispersion medium such as water to produce a spherical particle and then performing carbonization and activation, and (2) a method in which a raw material powder and a binder are subjected to rolling granulation to obtain a spherical form and then performing carbonization and activation.

As a method of performing carbonization and activation after a raw material is dispersed in a dispersion medium such as water to produce a spherical particle, in Patent Reference 1 (Published Examined Patent Application No. Sho 50-018879) and Patent Reference 2 (Published Unexamined Patent Application No. Sho 55-113608), there is described a method of producing a spherical carbon or a spherical activated carbon by fusing a pitch-based raw material, and dispersing and granulating the resultant material followed by infusibilization, carbonization and activation. In addition, in Patent Reference 3 (Published Unexamined Patent Application No. Hei 03-030834), Patent Reference 4 (Published Examined Patent Application No. Sho 46-41210) and Patent Reference 5 (Published Unexamined Patent Application No. Sho 50-51996), there are described a method in which a raw material powder and a binder are formed to a spherical form and then carbonization and activation are performed, and an activated carbon obtained by the method.

Patent Reference 1: Published Examined Patent Application No. Sho 50-018879

Patent Reference 2: Published Unexamined Patent Application No. Sho 55-113608

Patent Reference 3: Published Unexamined Patent Application No. Hei 03-030834

Patent Reference 4: Published Examined Patent Application No. Sho 46-41210

Patent Reference 5: Published Unexamined Patent Application No. Sho 50-5199

Non-patent Reference 1: Gas World Coking Section, 111 (1939) p. 106-111

### DISCLOSURE OF THE INVENTION

### Problems to be Solved by the Invention

An activated carbon having a high hardness is readily obtained by a method in which a raw material in a liquid state is dispersed in a dispersion medium to form a spherical form under the operating conditions as disclosed in Patent Reference 1 and Patent Reference 2. In this case, however, since it is required that the mixture is a liquid state at the stage of dispersing the raw material in the dispersion medium, a fusible raw material such as petroleum pitch is required to be used as a raw material, and a commonly-used carbon material such as coconut shell and typical coal cannot be used as a main raw material. Moreover, normally the fluidity is increased by using a solvent, however, in this case, the process becomes complex because an extra process is required to remove the solvent.

Further, since these methods are difficult to maintain large particles stably in a dispersion medium, it is generally difficult to produce industrially a spherical activated carbon having a diameter of 1 mm or more. In addition, when pitch and resin are formed to a spherical form and then are infusibilized and carbonized, the resultant spherical pitch and resin particles are closely adhered to each other, and thus a gas for infusibilization and carbonization is difficult to reach the inside of the particles if the particle diameter becomes larger and the volatile portions generated are difficult to be removed, thereby making it difficult to perform homogeneous infusibilization and carbonization. For this reason, in general, these methods have limitations in the surface area and absorption ability and are likely to cause the degradation due to the structural difference between the surface and the inside.

Meanwhile, in Patent Reference 3, Patent Reference 4 and Patent Reference 5, there are described a method of producing a spherical activated carbon by forming a raw material powder and a binder to a spherical form and then performing carbonization and activation or an activated carbon produced by the production methods thereof. According to these methods, a large activated carbon having a diameter of approximately a few mm may be produced by using an infusible solid carbon raw material such as coconut shell charcoal and coal, and the activation may be performed to the inside of the carbon because many microspores are contained even at the time when the spherical carbon is formed. However, the spherical activated carbon produced by these methods adversely has disadvantages in that the bulk density is difficult to be increased, the hardness is low and the dust generation property is low.

In these precedent references, it is described that the activated carbon of each invention has a high hardness and low dust generation property. However, the test results by the inventors of the present invention showed that the dust generation property of these activated carbons was not small enough for the strict requirement required in the applications previously mentioned.

In light of the above-mentioned situations, the object of the present invention is to provide a spherical activated carbon which is produced from an infusible solid carbon material as a raw material, would not cause any trouble attributed to dust generation when used for prevention of automobile fuel evaporation and has a small pressure loss.

### Means to solve the Problems

As a result of earnest studies to achieve the above-mentioned objectives, the present inventors have found that a spherical activated carbon having a high hardness may be produced from a commonly-used and useful raw material such as coconut shell and coal by a process comprising blending a raw material carbon powder with a binder, extruding the resultant mixture into a strand form, carrying out rolling granulation to obtain a spherical form, infusibilizing the same under appropriate conditions, and performing carbonization and thereafter activation under conditions appropriately restricting the contact with an activation gas, and the present inventors have completed the present invention.

That is, the present invention is a spherical activated carbon having a constant or more hardness which is produced by an infusible solid carbon material as a raw material.

### Effects of the Invention

The present invention may provide a spherical activated carbon produced from a commonly-used and useful carbon material such as coconut shell charcoal and coal as a raw material, which activated carbon has small dust generation, a low pressure loss and a relatively large particle diameter when in use. In addition, the present invention may provide a method of producing a spherical activated carbon having small dust generation and a relatively large particle diameter readily and industrially.

### BEST MODE FOR CARRYING OUT THE INVENTION

An activated carbon in the present invention is referred to as a spherical activated carbon produced from an infusible solid carbon material as a main raw material. Herein, “infusible” means that a raw material itself will not be fused to a liquid under conditions where it is granulated and infusibilized. In other words, a carbon material used as a raw material of the present invention has a melting point or decomposition point of 300° C. or more. Further, a carbon material means that the main ingredient comprises carbon and typically, is referred to as a material which is made up of carbon atoms comprising 60% by weight or more of the total weight after drying to remove water. Moreover, “as a main raw material” means that 50% by weight or more, preferably 70% by weight or more of the carbon content before infusibilization and carbonization is derived from the solid carbon material.

As an infusible solid carbon material used as a raw material of an activated carbon of the present invention, there may be mentioned charcoal, coconut shell charcoal, various coals and various materials such as anthracite, bituminous coal and the like. However, since an activated carbon which is easily available and has various properties may be produced, coconut shell charcoal and coal are preferable. Among them, coconut shell charcoal is especially preferable in that an activated carbon, which contains no hazardous impurities, is easily commercially available and has a suitable fine-pore structure, is readily manufactured.

The activated carbon of the present invention is a spherical activated carbon. Herein, “spherical” is referred to as a form having no sharp edges, which is different from a cylindrical pellet and pulverized granular activated carbon. Because of having a form having no such sharp edges, an activated carbon of the present invention is preferable in that it may suppress the defect caused by vibration and collision with other particles and dust generation caused by the defect. Moreover, an activated carbon of the present invention is preferable in that a pressure loss is likely constant without localization and drift is unlikely occur because such form is regularly filled. Herein, “spherical” may be a form not having the above-mentioned sharp edges. Among forms having no edges, it is preferable to be more close to a true sphere. Specifically, the ratio of long radius to short radius preferably is 1.0 to 2.0, and more preferably 1.0 to 1.5.

In order to prevent trouble caused by dust generated from an activated carbon in using the activated carbon, it is preferable that a hardness of a spherical activated carbon is high. Typically, a hardness of an activated carbon is represented by a hardness measured by a method specified by JIS K1474 (hereinafter, abbreviated as JIS hardness). However, conventionally, if the activated carbons have been used for the applications required for suppressing dust generation as mentioned above, the JIS hardness typically exceeds 98%. Therefore, if these conventional activated carbons and an activated carbon which shows clearly less dust generation than conventional carbons and high dust prevention are compared in JIS hardness, these differences are not clearly observed. Accordingly, it is difficult to evaluate whether an activated carbon may highly prevent high dust generation using JIS hardness as an index. Consequently, as a result of various studies to find a hardness measuring method which may clearly reflect the degree of dust generation, the present inventors have found that microstrength hardness (hereinafter represented by an MS hardness) well agrees with the degree of dust generation caused by the defect when in use, and adopted the MS hardness for evaluating an activated carbon of the present invention as an index.

The MS hardness measuring method in the present invention is a method in which the method used for measuring the hardness of coal is adjusted so as to adequately evaluate the particle diameter of an activated carbon to be covered by the present invention. The measuring method is summarized as follows. That is, 10 steel balls are added into a steel pot having an inside diameter of 25.4 mm and a length of 304.8 mm and further 5 g of a dried, granular activated carbon was added and sealed. The steel pot is attached to a measuring device and rotated at a velocity of 25 rpm for 40 minutes. After that, a sample is taken out and the steel balls are removed, and subsequently the sample is sieved in a vibrator for 5 minutes using a screen with an opening of 0.3 mm. The percentage, which is represented by the ratio of the sample that remained on the sieve to the sample that was initially added to the steel pot, is determined as the MS hardness.

Meanwhile, for the devices and the like which are not described in the above measuring method, measurements are carried out in accordance with a method described in Non-patent Reference 1 (Gas World Coking Section, 111 (1939) p. 106-111).

Since the above-mentioned MS hardness measuring method measures a remaining ratio after pulverizing activated carbons with steel balls and passing fragments through a particular screen, even if the materials to be measured are the same, the MS hardness is measured as a low value as long as the particle diameter at the starting time of measurement is small, and inversely is measured as a high value if that is large. That is, when the activated carbons originally have a larger particle diameter even if they are of the same material, the high values of the hardness are measured because they are not passed through the screen even if they are divided into fragments. When they originally have a smaller particle diameter, low values of the MS hardness are measured because they are passed through the screen even if they are not divided into fragments. Accordingly, when the hardness of an activated carbon is represented by the MS hardness, it is represented by a function of a particle diameter in order to reflect the inherent material hardness. As a result of various studies, the inventors have found out that, regarding the MS hardness of spherical activated carbons which are manufactured by almost the same method and have almost the same practical hardness, when the average particle diameter is represented by x (mm) and the MS hardness by y (%), the relationship of following equation (I) holds between x and y.
Y=100×(1−0.8×a^{(0.3-x)}) (I)

The above equation is empirical and the effects are as follows. First, the conditions to be satisfied by the MS hardness are reviewed. In the case where the particle diameter to be measured is homogeneous and the screen opening is smaller than the particle diameter x, the MS hardness is forced to be zero because particles to be measured are passed through a screen without any pulverizing. Inversely, if x is considerably larger, the MS hardness has to be approaching 100% because particles to be measured are not easily passed through a screen even after pulverizing.

At the same time, when the equation (I) is described in a general form, it is represented by the following equation (II).
Y=100×(1−c×a^{(b-x)}) (II)
In the equation (II), a^{(b-x)} represents a ratio of fragments having a diameter passing the screen after pulverizing at the time of measurement. b is an opening (mm) of a screen, and b equals 0.3 because a screen with an opening of 0.3 mm is used in the above measurements. In case of X=b, a^{(b-x)}=2 and a^{(b-x)}=0 if x is sufficiently large. Therefore, if c=0.1, the conditions to be theoretically satisfied by the MS hardness are satisfied in the absence of the above-mentioned particle diameter distribution to be measured. However, since an activated carbon has a particle diameter distribution and clogging happens even when the particle is smaller than the screen opening and parts remain on the screen, even in the case of a spherical carbon having an average particle diameter of 0.3 mm, the MS hardness will not be zero. In this way, the coefficient c of the equation is to adjust deviations from the ideal relationship, and as a result of investigating the relationship between the particle diameter and the MS hardness by measuring a spherical activated carbon of the present invention produced by the same method, which has various particle diameters in the range in which x is 0.5 or more and 20 or less, it is empirically concluded that C=0.8.

In the equation (I), if the value of a is large, the MS hardness in the same particle diameter becomes higher, and if the value of a is small, the MS hardness becomes lower. Therefore, it may be said that a is an index representing an absolute hardness of an activated carbon material. By judging from the measuring method of the MS hardness, the MS hardness will be 100% irrespective of the particle diameter if the particle to be measured is not at all pulverized and the particle diameter to be measured is homogeneous and the diameter is larger than the screen opening. In the above equation (I), as a increases, y approaches to 100% and therefore in this respect the equation (I) satisfies the condition desired by the MS hardness.

A spherical activated carbon of the present invention has a relationship between x and y in which y is 100×(1−0.8×1.45^{(0.3-x)}) or more in the range in which x is 0.5 or more and 20 or less, providing that the average particle diameter is x (MM) and the MS hardness is y (%), in other words, a is 1.45 or more in the above equation (I). In an activated carbon of the present invention, practically a higher hardness is preferable, and a in the equation (I) is preferably 1.60 or more. Meanwhile, the hardness is excessively increased, causing a problem that it becomes difficult to be compatible with the adsorption performance and it takes a long time to produce a spherical activated carbon. Therefore, a in equation (I) is preferably not more than 2.50, and more preferably not more than 2.10.

The resent inventors have studied earnestly to increase the hardness of a spherical activated carbon and succeeded in producing a spherical activated carbon having a high hardness which has not conventionally been produced from an infusible solid carbon material as a raw material. As a result of testing the resultant spherical activated carbons having various hardness and particle diameters, the present inventors have confirmed that a spherical activated carbon in which the MS hardness and the average particle diameter satisfy the above relationship significantly reduces trouble caused by fracturing and abrasion when in use in the applications described heretofore, compared to conventional spherical activated carbons, and the present inventors have reached the present invention.

The average particle diameter of a spherical activated carbon of the present invention is one as measured by JIS K-1474. That is, the average particle diameter is calculated by classifying activated carbons by using a screen specified by JIS and then by multiplying the weight fraction of the activated carbons classified by the median of the opening of the screen used for classification.

The particle diameter of a spherical activated carbon of the present invention is selected accordingly depending on the aspect of use. However, typically in the case where the spherical activated carbon is filled in a container and used by ventilating, if the particle diameter is too large, the contacting efficiency between the gas and the activated carbon is reduced, making it difficult to exhibit adsorption ability. Therefore, the average particle diameter is preferably 5.0 mm or less and more preferably 3.0 mm or less. Meanwhile, if the particle diameter is too small, the pressure loss tends to decrease in a state where a fluid is circulated. Accordingly, the average particle diameter is preferably 0.5 mm or more and more preferably 0.8 mm or more.

In general, if the hardness of an activated carbon is increased, the adsorption performance tends to decrease. The adsorption performance for the application for prevention of automobile fuel evaporation is represented by the benzene adsorption amount. Here, the benzene adsorption amount is measured in accordance with JIS K1474 of the measurement of adsorption performance of solvent evaporation and is represented by the benzene amount (% by weight) adsorbed to the weight unit of the activated carbon in the equilibrium adsorption at a concentration of one tenth of the saturated concentration. If the benzene amount adsorbed is too small, the adsorption ability often practically becomes insufficient, and if the benzene amount adsorbed is more than a given amount, it becomes increasingly difficult to increase the hardness. Therefore, the benzene amount adsorbed is preferably 25 to 65%. However, in the case of an activated carbon used for gas separation by using a pressure swing system gas separation apparatus, the benzene amount adsorbed may be lower than 25% because the molecule to be adsorbed is smaller than that of benzene.

A spherical activated carbon of the present invention may be subjected to chemical and physical treatments where necessary. As such surface modifications, there may be mentioned impregnation of a salt of metal such as silver and iron, an oxide and a mineral acid. Further, the spherical activated carbon may contain on the surface and/or inside other fine particles in the range where the inherent function of activated carbon is not impaired. As examples of these substances, there may be mentioned metal oxides such as silica, alumina, zeolite and the like.

Hereinafter, a method of producing a spherical activated carbon of the present invention is explained. The spherical activated carbon in the present invention may be produced by a process comprising mixing an infusible solid carbon material (hereinafter, may be abbreviated as a raw material carbon material) as a raw material with a carbonizable binder and water where necessary, extruding the mixture into a strand form; cutting the resultant strand to a suitable size and then carrying out rolling granulation so as to obtain a spherical form; infusibilizing the same under appropriate conditions corresponding to the particle diameter; and performing infusibilization, carbonization and activation under conditions appropriately restricting the contact between the formed mixture and a gas phase portion.

The raw material carbon material used here is not particularly limited as long as it is an infusible solid carbon material as mentioned above. However, coal and coconut shell charcoal are preferably used in view of the available readiness and the producibility of an activated carbon having various pores. Especially, coconut shell charcoal is favorably used because it contains no hazardous impurities and an activated carbon having a wide range of performance may be produced from it.

The particle size of the raw material carbon material may be selected depending on the purpose of use, however, if the particle diameter is too large, it becomes difficult to harden the carbon material, and the pore of the resultant spherical activated carbon becomes large, making it difficult to increase the hardness. Meanwhile, the particle diameter is too small, the operating efficiency in forming the carbon material is decreased. Therefore, as for the particle diameter of the raw material carbon material, the central particle diameter is preferably 1 μm to 100 μm and more preferably 5 μm to 20 μm.

As the carbonizable binder, there may be mentioned an organic material having a high boiling point such as coal tar, pitch, a thermosetting phenol resin and the like. The types and quantity of the binder are adjusted so that a raw material mixture is suitably softened at a temperature at which a raw material mixture is easily operated. In this viewpoint, the binder is softened preferably in the range of 40° C. to 100° C. Further, the quantity used of the carbonizable binder is preferably 20 to 60 parts by weight and more preferably 35 to 55 parts by weight with respect to 100 parts by weight of the carbon material.

In addition to the carbon material and the carbonizable binder, water is added if necessary. The addition amount of water is varied with the kind and particle diameter of the raw material carbon material and the type of the binder, and approximately 5 to 30 parts by weight of which is preferably added with respect to 100 parts by weight of the carbon material, in order to make it possible to facilitate the extrusion of the mixture in extruding to a strand and then obtain an excellent formability in carrying out rolling granulation.

In addition to the carbon material, carbonizable binder and water, other additives may be added as long as the inherent function of activated carbon of the present invention is not impaired. As such additives, there may be exemplified by an alkali metal compound such as lithium, sodium, potassium and the like, an alkaline earth metal compound such as magnesium, calcium and the like, other typical metals such as silicone, aluminum and the like and compounds thereof, a transition metal such as titanium, iron, copper, silver, zinc and the like and a compound thereof, and a complex oxide such as silica alumina, zeolite, activated white clay, clay and the like, which are added to improve functions, for example, to improve adsorption performance and provide catalytic performance. The amount of additives except for the binder and carbonizable binder, which is satisfactory to a degree that the function of the activated carbon is not impaired, is preferably not more than 30 parts by weight and more preferably not more than 10 parts by weight with respect to 100 parts by weight of the raw material carbon material.

The above-mentioned raw material carbon material, carbonizable binder, and water and other additives where necessary to are blended produce a carbon mixture. The conditions and blending device are determined accordingly depending on the type and composition of the carbon material and carbonizable binder. Conventionally well-known various blending machines may be adopted as a blending device, however, for example, there may be exemplified by a two-axis kneader blending machine, a one-axis kneader blending machine and the like. The temperature at the time of blending, which is not particularly limited as long as it is a temperature at which the binder maintains appropriate fluidity, is typically preferably 20 to 100° C. and more preferably 40 to 80° C.

The above-mentioned carbon material mixture obtained by mixing and blending is extruded into a strand form and cut to form a pellet having an appropriate diameter. This process is, for example, carried out by a pellet mill and the like. The nozzle bore diameter and cutting diameter are set depending on the targeted diameter of a spherical activated carbon. In obtaining a spherical activated carbon having a high hardness and high bulk density, it is important that a strand is thus formed once without directly forming the mixture to a spherical form. Although the reason is not necessarily clarified, it is estimated that a relatively large air bubble and variation in the composition, which are responsible for the cause of the structural defect in changing the carbon material mixture to the activated carbon, are solved by once blending and extruding the mixture. Further, it is important to cut the mixture as a strand once in order to obtain a product having a small particle diameter distribution, compared to a method of directly carrying out rolling granulation of a powder raw material and a binder.

The cut strand is formed to a spherical form by a method of rolling granulation and the like. In the case where rolling granulation is performed, a typical granulation apparatus may be used. As such apparatuses, there may be exemplified, for example, Malmelizer manufactured by Dalton Co., Ltd., High-speed Mixer manufactured by Fukae Powtec Co., Ltd. and the like. The temperature of rolling granulation is not specifically limited, however, the rolling granulation is carried out preferably at a temperature in the range of 40 to 100° C. because the temperature adjustment with a granulation machine is easy.

The spherical carbon material mixture obtained by forming a strand to a spherical form by the above-mentioned methods is formed as a spherical activated carbon through a process such as infusibilization, carbonization and activation and the like. In order to obtain an activated carbon having a high hardness, all these processes conditions are required to be suitably adjusted. Since the suitable conditions for obtaining a spherical activated carbon of the present invention are varied with the particle diameter of a spherical carbon material mixture, the type of a raw material carbon material and the type and amount used of a carbonizable binder and the like, they are generally difficult to be defined. However, in any processes, if the conditions are adjusted to the direction of suppressing the contact between the carbon material mixture and a gas, there is a tendency that an activated carbon having a high hardness is easily obtained.

The spherical carbon material mixture obtained by forming a strand to a spherical form is infusibilized under an atmosphere containing oxygen. Here, an atmosphere containing oxygen is referred to as ordinary air, or a mixed gas of oxygen and nitrogen, or a gas containing moisture, carbon dioxide and oxygen, and the like. Here, in order to increase the hardness of the finished product, it is desirable that the oxygen concentration, temperature, the situation and time of contacting with a gas are suitably adjusted depending on the particle diameter. The condition of infusibilization is adjusted so that an adequate oxidation velocity corresponding to the particle diameter of the spherical carbon is obtained. However, the infusibilization is typically preferably carried out at a temperature of not more than 400° C. and under an oxygen concentration of 5 to 22%. At this time, a suitable restriction of the contact with a gas is effective for the increase in hardness. Depending on the conditions of the spherical activated carbon material mixture, it is desirable that the contact with a gas is restricted so that suitable infusibilization may be typically carried out by performing the infusibilization for more than one hour including the temperature rising time. Here, as an apparatus used for infusibilization, one which is typically well-known may be used, however, there is preferably used a moving layer type device, for example, a rotary kiln, a Herreshoff type multistage floor furnace and a sleep furnace from the viewpoint that the contact with a gas may be easily controlled.

The spherical carbon infusibilized is subjected to carbonization treatment in an inert gas. The suitable conditions of carbonization are selected depending on the particle diameter, however, the temperature is preferably increased to a temperature approximately between 500 and 700° C. Here, an inert gas is referred to as a gas which is inert toward a carbon material in the above range of the temperature, typically means nitrogen and may be allowed to contain other nonoxidizable gases. Since the binder is carbonized by the infusibilization and carbonization treatment, the spherical activated carbon which is finally obtained does not substantially contain the binder. For the carbonization, the above-mentioned well-known devices which are usually used may be used.

The spherical carbon obtained by carbonization is further activated in an activation gas atmosphere, thereby there may be obtained a spherical activated carbon of the present invention having a high hardness and is excellent in prevention of dust generation. In order to obtain an activated carbon having a high hardness, it is desirable that the contact between a spherical carbon and the activation gas atmosphere is suitably restricted at the time of activation. For that purpose, there may be preferably used a moving layer type device such as a rotary kiln, a Herreshoff type multistage floor furnace and a sleep furnace. The suitable conditions of activation are required to be selected depending on the particle diameter, however, a temperature approximately between 800 and 1000° C. is preferably adopted. Here, an activation gas atmosphere referred to as moisture, carbon dioxide and a mixed gas thereof. As the activation gas atmosphere, there is preferably used an oil burning mixed gas which has a high moisture content and contains carbon dioxide. Here also, in order to produce a given activated carbon by controlling the contact with a gas, the activation is carried out preferably for more than 3 hours, and more preferably for more than 5 hours. Meanwhile, there is no problem to carry out the activation for a prolonged period of time by strictly restricting the contact with a gas, from a view point of obtaining an activated carbon having a high hardness. However, the activation time is practically preferably 60 hours or less because the production efficiency is reduced.

Since a spherical activated carbon of the present invention generates less dust when oscillation is applied or when it contacts with a high velocity gas, it is used for prevention of automobile fuel evaporation, and the like. Further, it is used for absorbing hazardous substances in a clean room for producing drugs and the like, is used for absorbing hazardous substances inside or in the vicinity of precision equipment and an electronic device which dislike dust, for example, for absorbing substances which exert an influence on a hard disk of computer and the like, and is used for the treatment of a constant or higher flow rate of a gas, for example, a pressure swing system gas separation device and the like.

Hereinafter, the present invention is explained with reference to Examples, but the present invention is not limited to these Examples.

### EXAMPLE 1

Coconut shell charcoal (carbon content: 85%) was pulverized with a pulverizer to obtain carbon particles having a particle diameter of 200 meshes or less (corresponding to a particle diameter of 75 μm). The central particle diameter of the resultant fine powders of the coconut shell charcoal was 10 μm. To 100 parts by weight of the fine powders of the coconut shell charcoal were added 40 parts by weight of coal tar (carbon content: 60%) and 10 parts by weight of water, and the mixture was kneaded with Versatile Mixing and Blending Device, 30DM Type (brand name) manufactured by Dalton Co., Ltd. at a revolution speed of 68 rpm for 20 minutes. The resultant mixture was extruded with a pellet mil (Type 2 (brand name) manufactured by Jyoda Iron Works Co., Ltd. into a strand form, which was cut to obtain an extruded material in a pellet form having a diameter of 1.6 mm and a length of 1.5 to 5 mm. The extruded material was formed by using High-speed Mixer FS-G Type (brand name) (volume:10 liters, diameter: 400 mm) manufactured by Fukae Powtec Co., Ltd. at 60° C. and at a revolution speed of 400 rpm) for 10 minutes to obtain a formed material in a spherical form having an average particle diameter of 2.3 mm.

The resultant spherical formed material was heated to 200° C. over 30 minutes by using a rotary kiln (diameter: 600 mm) at a revolution speed of 4 rpm and under an atmosphere of air and was infusibilized for 45 minutes and subsequently the resultant material was carbonized by heating to 600° C. over 60 minutes under an atmosphere of an inert gas in the same furnace. Further, the carbonized material was activated with a nitrogen gas and steam (the steam partial pressure: 49%) at 900° C. for 20 hours to obtain an spherical activated carbon having an average particle diameter of 1.8 mm.

The MS hardness of the resultant spherical activated carbon was 63.3%. Since the particle diameter x equals 1.8 mm, 100×(1−0.8×1.45^{(0.3-x)}) is 54.2, which value is exceeded by the MS hardness of this spherical activated carbon. Further, the benzene adsorption amount of this spherical activated carbon was 41.5%, the bulk density was 0.52 g/ml, and the ratio of long radius to short radius was in the range of 1 to 1.5.

### EXAMPLE 2

A process until the kneading is completed was performed under the same conditions as the above-mentioned Example 1, and the resultant mixture was extruded by a pellet mill into a strand form and the strand was cut to obtain an extruded material in a pellet form having a diameter of 3.5 mm and a length of 3 to 9 mm. The extruded material was treated under the same conditions as Example 1 to obtain a spherical activated carbon having an average particle diameter of 4.5 mm.

The MS hardness of the resultant spherical activated carbon was 91.9%. Since x equals 4.5 mm, 100×(1−0.8×1.45^{(0.3-x)}) is 83.2, which value is exceeded by the MS hardness of this spherical activated carbon. Further, the benzene adsorption amount of this spherical activated carbon was 43.0%, the bulk density was 0.54 g/ml, and the ratio of long radius to short radius was in the range of 1 to 1.5.

### EXAMPLE 3

A process until the kneading was performed under the same conditions as the above-mentioned Example 1, and the resultant mixture was extruded by a pellet mill into a strand form and the strand was cut to obtain an extruded material in a pellet form having a diameter of 0.8 mm and a length of 1 to 3 mm. The extruded material was treated under the same conditions as Example 1 to obtain a spherical activated carbon having an average particle diameter of 1.1 mm. The MS hardness of the resultant spherical activated carbon was 54.6% and the benzene adsorption amount was 41.6%. Since x equals 1.1, 100×(1−0.8×1.45^{(0.3-x)}) is 40.6, which value is exceeded by the MS hardness of this spherical activated carbon. Further, the bulk density of this spherical activated carbon was 0.56 g/ml and the ratio of long radius to short radius was in the range of 1 to 1.5.

### EXAMPLE 4

A spherical activated carbon was produced in the same manner as Example 1 except that a coal powder (anthracite which was produced to have 2.5% by weight of ash by washing (button index: 0, fixed carbon content: 85% by weight, particle diameter: not more than 75 μm, central particle diameter: 10 μm) is used in place of a coconut shell charcoal and the activation time was changed to 23 hours. However, the average particle diameter was adjusted to be 3.0 mm. The MS hardness of the resultant spherical activated carbon was 75.0%. Since x equals 3.0, 100×(1−0.8×1.45^{(0.3-x)}) is 70.7, which value is exceeded by the MS hardness. Further, the bulk density of this spherical activated carbon was 0.39 g/ml and the benzene adsorption amount was 58.6%.

Moreover, the butane working capacity (hereinafter referred to as BWC) of the spherical activated carbon was 14.6 g/100 ml as measured by ASTM D5228, which is an evaluation method of an activated carbon used for prevention of automobile fuel evaporation.

### EXAMPLE 5

A process until the kneading was performed under the same conditions as the above-mentioned Example 1, and the resultant mixture was extruded by a pellet mill into a strand form and the strand was cut to obtain an extruded material in a pellet form having a diameter of 2.3 mm and a length of 2 to 7 mm. The extruded material was formed by using High-speed Mixer FS-G Type (brand name) (volume:10 liters, diameter: 400 mm) manufactured by Fukae Powtec Co., Ltd. at 60° C. and at a revolution speed of 400 rpm for 10 minutes to obtain a formed material in a spherical form having an average particle diameter of 3.3 mm.

The resultant spherical formed material was heated to 200° C. over 30 minutes by using a rotary kiln (diameter: 600 mm) at a revolution speed of 4 rpm and under an atmosphere of air and infusibilized for 45 minutes and subsequently the resultant material was carbonized by heating to 600° C. over 60 minutes under an atmosphere of an inert gas in the same furnace. Further, the carbonized material was activated with a nitrogen gas and steam (the steam partial pressure: 49%) at 900° C. for 20 hours in a rotary kiln (400 mm in diameter) to obtain an spherical activated carbon having an average particle diameter of 2.6 mm.

The MS hardness of the resultant spherical activated carbon was 69.4% and the benzene adsorption amount was 42.1%. Since x equals 2.6, 100×(1−0.8×1.45^{(0.3-x)}) is 66.0, which value is exceeded by the MS hardness. Further, the bulk density of this spherical activated carbon was 0.51 g/ml and the ratio of long radius to short radius was in the range of 1 to 1.5.

### EXAMPLE 6

The spherical formed material having an average particle diameter of 3.3 mm, which was obtained under the same conditions as Example 5, was infusibilized and carbonized under the same conditions as Example 5 and subsequently the carbonized material was activated under the same conditions as Example 5 for 23 hours to obtain a spherical activated carbon having an average particle diameter of 2.5 mm. The MS hardness of the resultant spherical activated carbon was 68.2% and the benzene adsorption amount was 54.6%. Since x equals 2.5, 100×(1−-0.8×1.45^{(0.3-x)}) is 64.7, which value is exceeded by the MS hardness. Further, the bulk density of this spherical activated carbon was 0.44 g/ml and the ratio of long radius to short radius was in the range of 1 to 1.5.

### EXAMPLE 7

The spherical formed material having an average particle diameter of 3.3 mm, which was obtained under the same conditions as Example 5, was infusibilized and carbonized under the same conditions as Example 5 and subsequently the carbonized material was activated under the same conditions as Example 5 for 25 hours to obtain a spherical activated carbon having an average particle diameter of 2.5 mm. The MS hardness of the resultant spherical activated carbon was 65.7% and the benzene adsorption amount was 65.2%. Since x equals 2.5, 100×(1−0.8×1.45^{(0.3-x)}) is 64.7, which value is exceeded by the MS hardness. Further, the bulk density of this spherical activated carbon was 0.40 g/ml and the ratio of long radius to short radius was in the range of 1 to 1.5.

### COMPARATIVE EXAMPLE 1

A spherical activated carbon was produced in accordance with the examples described in Patent Reference 4 (Published Examined Patent Application No. Sho 46-41210). Weak coking coal having an ash of 3% was used as raw material coal, dried to the water content of 2% and subsequently pulverized to 100 meshes or less. To the resultant fine particle coal was added 20% by weight of pulp effluent separately prepared as coking coal based on raw material coal, and water was also secondarily added to adjust to a water content of 20%. The coal was adjusted to a water content of 12 to 15% in the examples of Patent Reference 4, however, coal having this range of the water content could not be formed to a spherical form. The mixture was thoroughly blended and was formed by using High-speed Mixer FS-G Type (volume:10 liters, diameter: 400 mm) manufactured by Fukae Powtec Co., Ltd. at 35° C. and at a revolution speed of 100 rpm for 10 minutes to obtain a spherical formed material having an average particle diameter of 2.3 mm. The resultant formed material was dried at 100° C., modified at 360° C. and then sintered at 530° C. to produce a carbon material which is suitable for carbonization. The resultant carbon material was carbonized at 900° C. in a rotary kiln, and further activated by steam for 2 hours by a fluidized-bed activation furnace under the conditions of 900° C. and a steam partial pressure of 40%. The average particle diameter of the resultant activated carbon was 1.8 mm.

The MS hardness of the resultant spherical activated carbon was 46.0% and the benzene adsorption amount was 32.2%. Therefore, since x equals 1.8, 100×(1−0.8×1.45^{(0.3-x)}) is 54.2, which value is exceeded by the MS hardness. Further, the bulk density of this spherical activated carbon was 0.47 g/ml and the ratio of long radius to short radius was in the range of 1 to 1.5. Meanwhile, Patent Reference 4 describes an activated carbon having a targeted product particle diameter of 3 to 10 mm, the MS hardness of 90%, a benzene adsorption amount of 30%. Although a particle diameter is not described in the above publication, assuming that the average particle diameter in the vicinity of center is 7.0 mm, 100×(1−0.8×1.45^{(0.3-x)}) is 93.4, which value is exceeded by the MS hardness. Moreover, since the value of a in equation (I), y=100×(1−0.8×a^{(0.3-x)}) of the spherical activated carbon of Comparative Example 1 corresponds to 1.34, and that of the activated carbon of Patent Reference 4 corresponds to 1.36 assuming that the average particle diameter is 7.0 mm, it may be said that the essential harness of the activated carbon of Comparative Example 1 and that of the activated carbon described in the above publication are almost the same.

### COMPARATIVE EXAMPLE 2

A spherical activated carbon was produced in the same manner as Example 1 except that the conditions of infusibilization was changed to 250° C. and 2 hours, and the activation was performed for 2 hours under the conditions of 850° C. and a steam partial pressure of 40% by using a fluidized-bed activation furnace. The average particle diameter of the spherical activated carbon was 2.0 mm, the MS hardness was 52.4% and the benzene adsorption amount was 38.2%. Since x equals 2.0, 100×(1−0.8×1.45^{(0.3-x)}) is 57.5, which value is exceeded by the MS hardness. Further, the bulk density of this spherical activated carbon was 0.49 g/ml and the ratio of long radius to short radius was in the range of 1 to 1.5.

### COMPARATIVE EXAMPLE 3

As a commercially available spherical activated carbon, the physical properties were measured for X-7000 (brand name) produced by Japan EnviroChemicals, Ltd., which had an average particle diameter of 1.6. The MS hardness was 28.6%, and since x equals 1.6, 100×(1−0.8×1.45^{(0.3-x)}) is 50.7, which value is exceeded by the MS hardness. Further, the benzene adsorption amount was 31.6%

### COMPARATIVE EXAMPLE 4

A spherical activated carbon was produced in accordance with the examples described in Patent Reference 3 (Published Unexamined Patent Application No. Hei 03-030834). Bituminous coal was used as raw material coal, dried to the water content of 2% and subsequently pulverized to 100 meshes or less. To the resultant fine particle coal were added 12 parts by weight of pulp effluent separately prepared as coking coal and simultaneously 8 parts by weight of water with respect to 100 parts by weight of raw material bituminous coal, and subsequently the mixture was blended by a batch type kneader to obtain a raw material carbon material mixture. Further, while water was being added to the mixture, the mixture was formed by using High-speed Mixer FS-G Type (brand name)(volume:10 liters, diameter: 400 mm) manufactured by Fukae Powtec Co., Ltd. at 40° C. and at a revolution speed of 100 rpm for 10 minutes to obtain a spherical formed material having an average particle diameter of 2.0 mm. The amount of water added was 25 parts by weight in total with respect to 100 parts by weight of raw material bituminous coal. The resultant spherical formed material was dried at 100° C., and carbonized by heating from 250° C. to 600° C. at a rate of 3.5° C./min under a flow of nitrogen gas in a rotary kiln (diameter: 600 mm). The resultant carbonized product was activated by steam (steam partial pressure: 49%) in a rotary kiln (diameter: 400 mm) at 900° C. The average particle diameter of the resultant activated carbon was 1.7 mm.

The MS hardness of the resultant spherical carbon was 37.3% and the benzene adsorption amount was 27.5%. Therefore, since x equals 1.7, 100×(1-0.8×1.45^{(0.3-x)}) is 52.4, which value is exceeded by the MS hardness. Further, the bulk density of this spherical activated carbon was 0.53 g/ml and the ratio of long radius to short radius was in the range of 1 to 1.5.

### REFERENCE EXAMPLE 1

The powdering percentage was measured for the activated carbons of Examples 1 to 7 and Comparative Examples 1 to 3. The powdering percentage referred here is represented by the concentration, which is obtained by putting 0.1 g of predried spherical activated carbon into a 100 ml conical flask equipped with a ground glass stopper, and shaking the flask at 200 rpm for 3 hours and then adding 25 ml of ethanol and shaking the flask at 140 rpm for 30 minutes and immediately taking out the suspension and measuring the absorbance at 650 nm by a absorptiometer, and finally converting the absorbance into the concentration of the suspension using standard curves prepared in advance. The above-mentioned powdering percentage becomes an index of dust generation property in the case where an activated carbon is used in a device for prevention of automobile fuel evaporation (a canister) and the like.

These results are shown together with the results of Examples and Comparative Examples in Table 1. Incidentally, in the Examples 1 and 3, since the concentration of the suspension exceeds the upper limit of the absorbance measurement in the above-mentioned measuring method, the measurement was performed by further diluting the suspension by ten-fold. In addition, the value of a is also described when the relationship between the average particle diameter x and the MS hardness y is substituted to the relationship equation, y=100×(1−0.8×a^{(0.3-x)}). It is indicated that, as the MS hardness increases, the powdering percentage is improved, and in the Examples which exceed a=1.45, the powdering percentage which is not more than 1% is within a range having no practical problems.

TABLE 1

| | Average | | | Bz | | | |
|---|---|---|---|---|---|---|---|
| | Particle | MS | | Adsorption | Bulk | Powdering | JIS |
| Activated | Diameter | Hardness | a | Amount | density | Percentage | Hardness |
| carbon | (mm) | (%) | value | (%) | (g/cc) | (%) | (%) |
| Example 1 | 1.8 | 63.3 | 1.68 | 41.5 | 0.52 | 0.56 | 99.8 |
| Example 2 | 4.5 | 91.9 | 1.73 | 43.0 | 0.54 | 0.80 | 99.8 |
| Example 3 | 1.1 | 54.6 | 2.03 | 41.6 | 0.58 | 0.45 | 99.8 |
| Example 4 | 3.0 | 75.0 | 1.54 | 58.6 | 0.39 | 0.65 | 99.8 |
| Example 5 | 2.6 | 69.4 | 1.52 | 42.1 | 0.51 | 0.87 | 99.8 |
| Example 6 | 2.5 | 68.2 | 1.52 | 54.6 | 0.44 | 0.71 | 99.8 |
| Example 7 | 2.5 | 65.7 | 1.47 | 65.2 | 0.40 | 0.59 | 99.8 |
| Comparative | 1.8 | 46.0 | 1.34 | 32.2 | 0.47 | 2.40 | 92.0 |
| Example 1 | | | | | | | |
| Comparative | 2.0 | 52.4 | 1.36 | 38.2 | 0.49 | 1.24 | 99.2 |
| Example 2 | | | | | | | |
| Comparative | 1.6 | 28.6 | 1.09 | 31.6 | 0.45 | 2.98 | 95.3 |
| Example 3 | | | | | | | |
| Comparative | 1.7 | 37.3 | 1.19 | 27.5 | 0.53 | 2.40 | 99.2 |
| Example 4 | | | | | | | |

### INDUSTRIAL APPLICABILITY

An activated carbon of the present invention is suitably used for a device for prevention of automobile fuel evaporation (a canister), a pressure swing system gas separation and the removal of hazardous substances under the environment which cannot allow dust and the like.

1: A spherical activated carbon produced from an infusible solid carbon material as a raw material, characterized in that providing that x (mm) represents an average particle diameter and y (%) an MS hardness, in the range in which x is 0.5 or more and 20 or less, y is 100×(1−0.8×1.45^{(0.3-x)}) or less.

2: The spherical activated carbon according to claim 1, characterized in that the infusible solid carbon material is at least one selected from coconut shell charcoal and coal.

3: The spherical activated carbon according to claim 1, characterized in that an average particle diameter of the spherical activated carbon is 0.5 mm or more and 5.0 mm or less.

4: The spherical activated carbon according to claim 1, characterized in that a benzene adsorption amount of the spherical activated carbon is 25% or more and 65% or less.

5: The spherical activated carbon according to claim 1, characterized in that the spherical activated carbon is an activated carbon used for prevention of automobile fuel evaporation.

6: A method of producing the spherical activated carbon according to claim 1, comprising the steps of: once extruding a mixture containing 100 parts by weight of an infusible solid carbon material and 20 to 60 parts by weight of a carbonizable binder to a strand form; cutting the strand and then carrying out rolling granulation so as to obtain a spherical form; infusibilizing the same under an atmosphere having an oxygen concentration of more than 5% to 22% at 400° C. or less; performing carbonization under an atmosphere of inert gas at a temperature of 500 to 800° C.; and performing activation treatment in an atmosphere having a steam partial pressure of 10 to 70% at a temperature of 800 to 1000° C.
